(19) United States
(12) Patent Application Publication
(10) Pub. No.: US 2025/0381523 A1
(43) Pub. Date: Dec. 18, 2025

(54) WALL-FLOW FILTER AND METHODS FOR INHIBITING RELEASE OF VERY FINE NANO-PARTICLES IN EXHAUST EMISSIONS

(71) Applicant: CORNING INCORPORATED, CORNING, NY (US)

(72) Inventor: Dominik Rose, Wiesbaden (DE)

(21) Appl. No.: 18/878,170

(22) PCT Filed: Jul. 21, 2023
(86) PCT No.: PCT/US2023/028337

§ 371 Date: Dec. 23, 2024

Related U.S. Application Data
(60) Provisional application No. 63/391,271, filed on Jul. 21, 2022.
(60) Provisional application No. 63/426,126, filed on Nov. 17, 2022.

(51) Int. Cl. B01D 53/94; B01D 46/24; B01J 23/10; B01J 35/57; F01N 3/022; F01N 3/035

(52) U.S. Cl. CPC B01D 53/94; B01D 46/2418; B01J 23/10; B01J 35/57; F01N 3/0222; F01N 3/035; B01D 2255/2065; B01D 2255/20715; B01D 2255/2092; B01D 2255/407; B01D 2255/9155; B01D 2257/702; B01D 2258/012; B01D 2279/30; F01N 2510/06

(57) ABSTRACT

A wall-flow filter for inhibiting the emission of very fine nano-particles. The wall-flow filter includes a honeycomb body including an intersecting array of filter walls formed of a porous material and defining channels extending through the honeycomb body between an inlet face and an outlet face of the filter. The channels comprise a plurality of inlet channels that are open at the inlet face and plugged at the outlet face and a plurality of outlet channels that are open at the outlet face and plugged at the inlet face. A mixed metal oxide particle deposition is located on and/or in the filter walls of the wall-flow filter. The mixed metal oxide particle deposition comprises precious metals in an amount of less than 0.1 wt %.

### CROSS REFERENCE TO RELATED APPLICATION

This application claims the benefit of priority under 35 U.S.C. § 119 of U.S. Provisional Application Ser. No. 63/426,126 filed Nov. 17, 2022, and U.S. Provisional Application Ser. No. 63/391,271 filed on Jul. 21, 2022, the content of which is relied upon and incorporated herein by reference in their entireties.

### FIELD

This disclosure relates to exhaust aftertreatment systems, more specifically to wall-flow filters useful in exhaust aftertreatment systems for inhibiting the emission of particulate matter, and even more particularly to aftertreatment systems having a mixed metal oxide particle deposition and methods of preventing the emission of very fine particulate matter therewith.

### BACKGROUND

The exhaust emissions of internal combustion engines, such as those used in automobile, vehicular, or other applications may be subject to various emissions standards or regulations, such as those enacted by governmental agencies. For example, regulations may set acceptable maximum values for emissions of one or more emissions components, such as carbon monoxide, nitrous oxides, or solid particulate matter. In the case of particulate matter, emissions are often regulated with respect to total particulate mass (“PM”) or the count or number of particles (“PN”). Furthermore, theses PM and/or PN standards may be defined with respect to a particle size value or range. For example, “PN23” or “PN 23nm” can be used to refer to the determined number of particles in the exhaust emissions that are 23 nanometers or larger in size, while “PN10” or “PN 10nm” refers to the determined number of particles in the exhaust stream that are 10 nm or larger in size.

In general, exhaust emissions regulations have continued to tighten over time, such as by regulating the control of increasingly smaller particulate sizes (e.g., shifting from PN23-based emissions standards to PN10-based emissions standards). Accordingly, methods and systems are desired to achieve evolving emissions regulations and standards. Exhaust aftertreatment systems can be employed that comprise a filter (e.g., which may be referred to as a “particulate filter” or “wall-flow filter”) to assist in achieving various emissions regulations or standards related to emission of particulate matter.

### SUMMARY

Disclosed herein are wall-flow filters for inhibiting the emission of very fine nano-particles. In embodiments, a wall-flow filter comprises a honeycomb body comprising an intersecting array of filter walls formed of a porous material and defining channels extending through the honeycomb body between an inlet face and an outlet face of the filter, wherein the channels comprise a first plurality of inlet channels that are open at the inlet face and plugged at the outlet face and a second plurality of outlet channels that are open at the outlet face and plugged at the inlet face; and a mixed metal oxide particle deposition on surfaces of the filter walls, in the porous material of the filter walls, or a combination thereof; wherein the mixed metal oxide particle deposition comprises precious metals in an amount of less than 0.1 wt %.

In embodiments, the mixed metal oxide particle deposition comprises a ceria-containing material.

In embodiments, the mixed metal oxide particle deposition comprises a combination of ceria and zirconia.

In embodiments, the ceria and zirconia are in solid solution.

In embodiments, the solid solution comprises a higher percentage of ceria than zirconia.

In embodiments, the solid solution comprises at least 50 wt % ceria.

In embodiments, the mixed metal oxide particle deposition comprises a combination of ceria and alumina.

In embodiments, the mixed metal oxide particle deposition comprises a combination of ceria, zirconia, and alumina.

In embodiments, the ceria-containing material has a particle size of from 1 μm to 5 μm.

In embodiments, the mixed metal oxide particle deposition has a loading of at least 5 g/L, with respect to a volume of the filter.

In embodiments, the loading of the mixed metal oxide particle deposition is from 5 g/L to 50 g/L.

In embodiments, the loading of the mixed metal oxide particle deposition is at least 10 g/L.

In embodiments, the mixed metal oxide particle deposition comprises ceria in an amount of at least 25 wt %.

In embodiments, the very fine nano-particles have a particle size of less than 23 nm.

In embodiments, the very fine nano-particles have a particle size of from 10 nm to less than 23 nm.

In embodiments, the particle deposition comprises no precious metals.

Disclosed herein are also methods of inhibiting the release of nano-sized particulate matter from an engine exhaust stream. In embodiments, a method comprises flowing an exhaust stream through a wall-flow filter, such as a wall-flow filter as described in any of the preceding paragraphs; filtering particulate matter from the exhaust stream with the wall-flow filter; interacting at least some of the gaseous hydrocarbon species collected in the filter with particles of a mixed metal oxide particle deposition at or downstream of the filter to inhibit creation of very fine nanoparticles, wherein the mixed metal oxide particle deposition comprises precious metals in an amount of less than 0.1 wt %.

Further disclosed herein are exhaust aftertreatment systems. In embodiments, an exhaust aftertreatment system comprises a wall-flow filter comprising a first honeycomb body comprising an intersecting array of filter walls formed of a porous material and defining channels extending through the honeycomb body between an inlet face and an outlet face of the filter, wherein the channels comprise a first plurality of inlet channels that are open at the inlet face and plugged at the outlet face and a second plurality of outlet channels that are open at the outlet face and plugged at the inlet face; a mixed metal oxide particle deposition at or downstream of the filter; wherein the deposition comprises precious metals in an amount of less than 0.1 wt %.

In embodiments, the mixed metal oxide deposition is on surfaces of the filter walls or in the porous material of the filter walls of the wall-flow filter.

In embodiments, the mixed metal oxide deposition is carried by a downstream substrate located downstream of the wall-flow filter.

In embodiments, the exhaust aftertreatment comprises an upstream substrate that carries a catalyst material, wherein the catalyst material comprises precious metals.

It is to be understood that both the foregoing general description and the following detailed description are merely exemplary, and are intended to provide an overview or framework to understanding the nature and character of the claimed subject matter. The accompanying drawings are included to provide a further understanding and are incorporated in and constitute a part of this specification. The drawings illustrate one or more embodiment(s), and together with the description, serve to explain principles and operation of the various embodiments.

### BRIEF DESCRIPTION OF THE DRAWINGS

FIG. 1 illustrates a honeycomb body according to embodiments disclosed herein.

FIG. 2 illustrates a filter according to embodiments disclosed herein.

FIG. 3 illustrates a cross-section of a filter such as that of FIG. 2.

FIG. 4 illustrates a portion of a porous wall of a honeycomb body of a filter having a mixed metal oxide particle deposition therein.

FIGS. 5A-5C illustrate three example scenarios of operation of an engine with an exhaust aftertreatment comprising filters with and without a mixed metal oxide particle deposition under different operating conditions.

FIGS. 6A and 6B illustrate portions of example exhaust aftertreatment systems comprising a mixed metal oxide particle deposition respectively on and downstream of a particulate filter according to embodiments disclosed herein.

FIGS. 7A and 7B show comparative filtration performance of two filters, one with and one without a mixed metal oxide particle deposition, with respect to particles greater than 23 nm and particles greater than 10 nm, respectively.

FIG. 8 shows comparative filtration performance of four filters under different operating conditions, with respect to particulate emissions for the number of particles greater than 10 nm in size (PN10).

FIG. 9 is a test cycle used to simulate a Real Driving Emissions (RDE) test that was utilized to test gasoline particulate filters according to examples described herein.

FIG. 10 illustrates a first graph for cumulative particulate emissions, a second graph for exhaust aftertreatment system temperature, and a third graph for vehicle speed for an implemented test cycle, each together plotted with respect to a common time scale.

FIG. 11A illustrates a graph showing the rate of very fine nanometer particle (PN10-PN23) emission per second with respect to exhaust aftertreatment system temperature for various tested gasoline particulate filters as described herein.

FIG. 11B is an enlarged view of a portion of the graph indicated in FIG. 11A.

### DETAILED DESCRIPTION

Reference will now be made in detail to exemplary embodiments which are illustrated in the accompanying drawings. Whenever possible, the same reference numerals will be used throughout the drawings to refer to the same or like parts. The components in the drawings are not necessarily to scale, emphasis instead being placed upon illustrating the principles of the exemplary embodiments.

Numerical values, including endpoints of ranges, can be expressed herein as approximations preceded by the term “about,” “approximately,” or the like. In such cases, other embodiments include the particular numerical values. Regardless of whether a numerical value is expressed as an approximation, two embodiments are included in this disclosure: one expressed as an approximation, and another not expressed as an approximation. It will be further understood that an endpoint of each range is significant both in relation to another endpoint, and independently of another endpoint.

According to the embodiments disclosed herein, the formation and/or release of solid particulate smaller than about 23 nanometers, such as from 10 nanometers to 23 nanometers in an exhaust stream can be reduced, prevented, or otherwise inhibited by use of a mixed metal oxide particle deposition that comprises essentially no precious metal (e.g., less than 0.1 wt %).

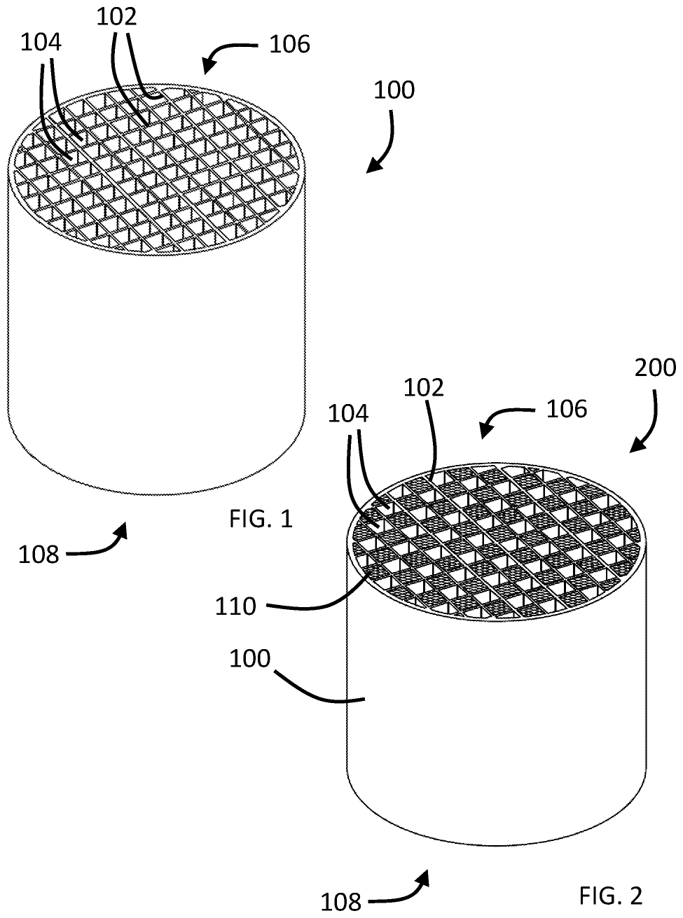

With reference now to FIG. 1, a honeycomb body 100 according to one or more embodiments shown and described herein is depicted. The honeycomb body 100 comprises an intersecting matrix or array of walls 102, which define a plurality of channels 104. The plurality of channels 104 and intersecting channel walls 102 extend between first face or end 106, which may be an inlet end, and second face or end 108, which may be an outlet end, of the honeycomb body. The honeycomb body 100 can also include an outer or peripheral skin layer circumferentially surrounding the honeycomb structure formed by the walls 102 and the channels 104. The skin layer can be extruded during the formation of the honeycomb body or formed in later processing as an after-applied skin layer, such as by applying a skinning cement to the outer peripheral portion of the channels.

The honeycomb body 100 can have one or more of the channels plugged by plugs 110 on one or both of the first end 106 and the second end 108, as shown in FIG. 2. The pattern for the plugs 110 for the honeycomb body is not limited. In some embodiments, a pattern of plugged and unplugged channels at one end of the honeycomb body is, for example, a checkerboard pattern where alternating channels 104 at each end of the honeycomb body are plugged by the plugs 110. In some embodiments, plugged channels at a first end of the honeycomb body have corresponding unplugged channels at the opposite end, and unplugged channels at the opposite end of the honeycomb body have corresponding plugged channels at the first end (e.g., the channels 104 that are plugged at the end 106 are unplugged at the end 108, and the channels 104 that are unplugged at the end 106 are plugged at the end 108).

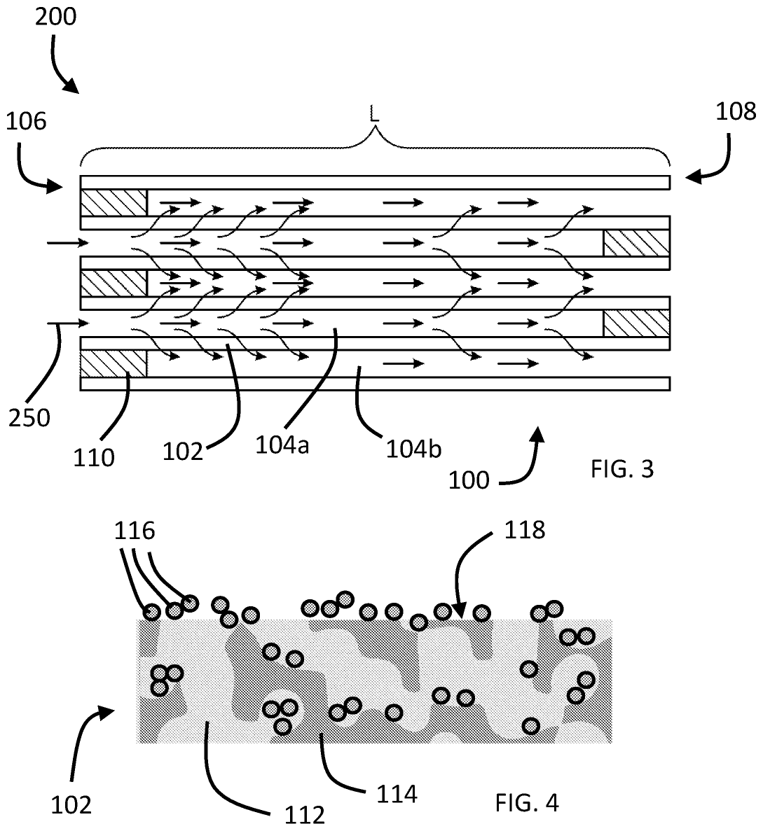

Referring now to FIGS. 2 and 3, a particulate or wall-flow filter 200 is depicted. The filter 200 can be used to filter particulate matter from an exhaust gas stream (e.g., an exhaust gas stream 250 in FIG. 3), such as an exhaust gas stream emitted from a gasoline or diesel engine. Accordingly, the filter 200 can be arranged as and/or referred to as a gasoline particulate filter or a diesel particulate filter, depending on its application. The filter 200 generally comprises a honeycomb body, such as the honeycomb body 100 comprising the array of intersecting walls 102 that define the plurality of channels 104 extending between the inlet face 106 and the outlet face 108. The distance between the faces 106 and 108 can be defined as a length L (shown in FIG. 3) of the honeycomb body 100 and/or filter 200.

In embodiments of the particulate filter 200, at least a first set of channels may be plugged with plugs 110. Generally, the plugs 110 are arranged proximate the ends (i.e., the inlet end 106 and/or the outlet end 108) of the channels 104. The plugs 110 are generally arranged in a pre-defined pattern, such as in the checkerboard pattern shown in FIG. 2, with every other channel being plugged. Those of the channels 104 plugged at or near the outlet end 108 and open at the inlet face 106 may be referred to as inlet channels, while those of the channels 104 plugged at or near the inlet face 106 and open at the outlet face 108 may be referred to as outlet channels. Accordingly, each channel can be plugged at or near one of the faces of the particulate filter only.

An axial cross section of a few of the channels of the particulate filter 200 of FIG. 2 is shown in FIG. 3 (exaggeratedly not to scale to emphasize features of the filter 200). The channels 104 open at the inlet face 106 and plugged at the outlet face 108 may be designated as or referred to as inlet channels, while others of the channels 104 that are plugged at the inlet face 106 and open at the outlet face 108 are designated as outlet channels. In this way, as shown via arrows in FIG. 3, the gas stream 250 enters the inlet channels, one of which is designated in FIG. 3 as inlet channel 104a, and flows through the porous walls 102 to one or more adjacent outlet channels, one of which is designated in FIG. 3 as outlet channel 104b. In this way, particulate matter entrained in or carried by the exhaust stream 250 is trapped within the inlet channels (e.g., the inlet channel 104a), while the filtered portion of the exhaust stream 250 exits the filter 200 via the outlet channels (e.g., the outlet channel 104b).

While FIG. 2 generally depicts a checkerboard plugging pattern, alternative plugging patterns may be used in the porous ceramic honeycomb article. The particulate filter 200 can be formed with a channel density of generally up to about 600 channels (or cells) per square inch (cpsi). For example, in some embodiments, the particulate filter 200 may have a channel density in a range from about 100 cpsi to about 600 cpsi. In some other embodiments, the particulate filter 200 may have a channel density in a range from about 100 cpsi to about 400 cpsi or even from about 200 cpsi to about 300 cpsi.

In one or more embodiments, the honeycomb body may be formed from cordierite, aluminum titanate, enstatite, mullite, forsterite, corundum, silicon carbide, spinel, sapphirine, and periclase. In general, cordierite has a composition according to the formula Mg₂Al₄Si₅O₁₈. In some embodiments, the pore size of the ceramic material, the porosity of the ceramic material, and the pore size distribution of the ceramic material are controlled, for example by varying the particle sizes of the ceramic raw materials. In addition, pore formers can be included in ceramic batches used to form the honeycomb body to influence the resulting pore size characteristics of the porous ceramic material of the honeycomb body 100 (and thus, the filter 200 formed from the honeycomb body 100).

In embodiments, the walls 102 of the honeycomb body 100 can have an average wall thickness from greater than or equal to 25 μm (approximately 1 mil) to less than or equal to 300 μm (approximately 12 mils), such as from greater than or equal to 50 μm (approximately 2 mils) to less than or equal to 280 μm (approximately 11 mils), greater than or equal to 65 μm (approximately 2 mils) to less than or equal to 255 μm (approximately 10 mils), or approximately about 200 μm (approximately 8 mils), such as from 150 μm (approximately 6 mils) to 255 μm (approximately 10 mils), although other sizes can be used.

In embodiments, the honeycomb body 100 (prior to or separate from any subsequent particle depositions) has a median pore size from greater than or equal to 6 μm to less than or equal to 25 μm, such as from greater than or equal to 7 μm to 15 μm, from greater than or equal to 7 μm to 13 μm, from greater than or equal to 7 μm to 10 μm, from greater than or equal to 8 μm to less than or equal to 20 μm, from greater than or equal to 8 μm to less than or equal to 18 μm, from greater than or equal to 8 μm to less than or equal to 15 μm, from greater than or equal to 8 μm to less than or equal to 12 μm, from greater than or equal to 9 μm to less than or equal to 20 μm, from greater than or equal to 9 μm to less than or equal to 18 μm, from greater than or equal to 9 μm to less than or equal to 15 μm, from greater than or equal to 9 μm to less than or equal to 12 μm, or from about 9 μm to about 11 μm. For example, in some embodiments, the honeycomb body 100 can have median pore sizes of about 10 μm, about 11 um, about 12 μm, about 13 μm, about 14 μm, about 15 μm, about 16 μm, about 17 μm, about 18 μm, about 19 μm, or about 20 μm. Generally, pore sizes of any given material exist in a statistical distribution. Thus, the term “median pore size” or “d50” (prior to or separate from any subsequent particle depositions) refers to a measurement above which the pore sizes of 50% of the pores lie and below which the pore sizes of the remaining 50% of the pores lie, based on the statistical distribution of all the pores. Pores in ceramic bodies can be manufactured by at least one of: (1) inorganic batch material particle size and size distributions; (2) furnace/heat treatment firing time and temperature schedules; (3) furnace atmosphere (e.g., low or high oxygen and/or water content), as well as; (4) pore formers, such as, for example, polymers and polymer particles, starches, wood flour, hollow inorganic particles and/or graphite/carbon particles. In specific embodiments, the median pore size (d50) of the honeycomb body (prior to or separate from any subsequent particle depositions) is in a range of from 10 μm to about 25 μm, for example 13-20 μm.

In specific embodiments, a deposition of filtration particles, separate from the mixed metal oxide particle deposition described further herein, can be performed to enhance the filtration efficiency of the particulate filter 200. For example, filtration particles can be deposited in accordance with US Patent Publication 2021/0354071 to Addiego et al. (hereinafter the '071 Publication), the contents of which are hereby incorporated in their entirety. Other filtration particle deposition processes include dry powder depositions, slurry coating processes (on green or fired honeycomb bodies), pyrolysis processes, or other processes for depositing filtration particles.

In embodiments, the honeycomb body 100 has a porosity (prior to or separate from any subsequent particle depositions), of from greater than or equal to 50% to less than or equal to 75% as measured by mercury intrusion porosimetry, although other porosities can be used. Other methods for measuring porosity include scanning electron microscopy (SEM) and X-ray tomography, these two methods in particular are valuable for measuring surface porosity and bulk porosity independent from one another, although all porosity values are provided herein with respect to mercury intrusion porosimetry unless stated otherwise. In embodiments, the porosity of the honeycomb body can be at least 45%, at least 50%, at least 55%, at least 60%, or even at least 65%, such as in a range of from about 50% to about 75%, in a range of from about 50% to about 70%, in a range of from about 50% to about 65%, in a range of from about 50% to about 60%, in a range of from about 50% to about 58%, in a range of from about 50% to about 56%, in a range of from about 50% to about 54%, in a range of from about 55% to 75%, in a range of from about 60% to 75%, or in a range of from about 65% to 75%, for example.

In the embodiments described herein, the channel walls 102 of the particulate filter 200 may have a thickness of greater than about 4 mils (101.6 μm). For example, in some embodiments, the thickness of the channel walls 102 may be in a range from about 4 mils up to about 30 mils (762 μm). In some other embodiments, the thickness of the channel walls 102 may be in a range from about 5 mils (177.8 μm) to about 20 mils (508 μm), such as from 6 mils to 10 mils.

In embodiments of the particulate filter 200 described herein, the channel walls 102 of the particulate filter 200 may have a “bare” open porosity (i.e., the porosity before any coating or deposition is applied to the honeycomb body) % P≥35%. In some embodiments the bare open porosity of the channel walls 102 may be such that 40%≤% P≤75%. In other embodiments, the bare open porosity of the channel walls 102 may be such that 45%≤% P≤75%, 50%≤% P≤75%, 55%≤% P≤75%, 60%≤% P≤75%, 45%≤% P≤70%, 50%≤% P≤70%, 55%≤% P≤70%, or 60%≤% P≤70%.

Further, in some embodiments, the channel walls 102 of the particulate filter 200 are formed such that the pore distribution in the channel walls 102 has a median pore size of ≤30 μm prior to the application of any coatings (i.e., when bare). For example, in some embodiments, the median pore size may be ≥8 μm and less than or ≤30 μm. In other embodiments, the median pore size may be ≥10 μm and less than or ≤30 μm. In other embodiments, the median pore size may be ≥10 μm and less than or ≤25 μm. In some embodiments, particulate filters produced with a median pore size greater than about 30 μm have been found to generally exhibit reduced filtration efficiency while particulate filters produced with a median pore size less than about 8 μm may be difficult to infiltrate the pores with a washcoat, e.g., for the mixed metal oxide particle deposition described herein. However, the use of smaller pore sizes is feasible by the use of smaller particle sizes for the mixed metal oxide particle deposition. Accordingly, in some embodiments, it is desirable to maintain the median pore size of the channel wall in a range of from about 8 μm to about 30 μm.

In one or more embodiments described herein, the honeycomb body 100 of the particulate filter 200 is formed from a ceramic material such as, for example, cordierite, silicon carbide, aluminum oxide, aluminum titanate or any other ceramic material suitable for use in elevated temperature particulate filtration applications. For example, the particulate filter 200 may be formed from cordierite by mixing a batch of ceramic precursor materials which may include constituent materials suitable for producing a ceramic article which predominately comprises a cordierite crystalline phase. In general, the constituent materials suitable for cordierite formation include a combination of inorganic components including a magnesia-source, a silica source, and an alumina source. The batch composition may comprise talc, alumina, and clay, such as, for example, kaolin clay. The cordierite precursor batch composition may also contain organic components, such as organic pore formers, which are added to the batch mixture to achieve the desired pore size distribution. For example, the batch composition may comprise a starch which is suitable for use as a pore former and/or other processing aids. Alternatively, the constituent materials may comprise one or more cordierite powders suitable for forming a sintered cordierite honeycomb structure upon firing as well as an organic pore former material.

The batch composition may additionally comprise one or more processing aids such as, for example, a binder, such as methylcellulose, and a liquid vehicle, such as water or a suitable solvent. The processing aids are added to the batch mixture to assist in mixing, extrusion, forming, or other property of the batch mixture and to generally improve processing, reduce the drying time, reduce cracking upon firing, increase green strength, and/or aid in producing the desired properties in the honeycomb body. For example, the binder can include an organic binder. Suitable organic binders include water soluble cellulose ether binders such as methylcellulose, hydroxypropyl methylcellulose, methylcellulose derivatives, hydroxyethyl acrylate, polyvinylalcohol, and/or any combinations thereof. Incorporation of the organic binder into the plasticized batch composition allows the plasticized batch composition to be readily extruded. In some embodiments, the batch composition may include one or more optional forming or processing aids such as, for example, a lubricant which assists in the extrusion of the plasticized batch mixture. Exemplary lubricants can include tall oil, sodium stearate or other suitable lubricants.

After the batch of ceramic precursor materials is mixed with the appropriate processing aids, the batch of ceramic precursor materials is extruded and dried to form a green honeycomb body as generally described with respect to the honeycomb body 100 of FIG. 1. Thereafter, the green honeycomb body is fired according to a firing schedule suitable for producing a fired honeycomb body, which also resembles the honeycomb body 100, albeit comprises from a porous ceramic material instead of a green ceramic-forming mixture. At least a first set of the channels of the fired honeycomb body are then plugged in a predefined plugging pattern with a plugging mixture, which may be dried or heated to assist in setting the plugging mixture to form a filter, e.g., as described with respect to the filter 200.

FIG. 4 illustrates a representative portion of the porous walls 102, schematically showing a porous network 112 (light gray) intertwined with solid material 114 (darker gray) of the porous material of the walls 102. The porous network 112 is interconnected to provide a path for the exhaust stream to flow through the walls 102 as illustrated with respect to the exhaust stream 250 in FIG. 3. As described further herein, the filter 200 can comprise a mixed metal oxide particle deposition 116. This mixed metal oxide particle deposition 116 can be formed by depositing particles on outer surfaces 118 of the walls 102 (“on-wall”), within the porous network 112 (“in-wall”), or a combination of both on-wall and in-wall depositions.

As described herein, the mixed metal oxide particle deposition 116 advantageously inhibits the emission of very fine nanoparticles from exhaust streams filtered by the filter 200. Very fine nanoparticles as referred to herein includes those less than 23 nm, such as those having a size of about 10 nm to less than 23 nm. As further described herein, the mixed metal oxide particle deposition 116 inhibits the emission of these very fine nanoparticles without the inclusion of precious metals that would typically be found in catalyst coatings applied to catalytically-active aftertreatment components (e.g., catalytic converters or catalyst-loaded filters). As referred to herein, the term “precious metals” includes platinum group metals, such as platinum, ruthenium, rhodium, palladium, osmium, and iridium, as well as gold and silver. In embodiments, the mixed metal oxide particle deposition 116 comprises substantially no precious metal (e.g., at most a trace amount), such as precious metal particles in an amount of less than 0.1 wt %, or even no precious metal (0 wt %).

In embodiments, the mixed metal oxide particle deposition 116 comprises a non-precious metal active component in the form of ceria or a ceria-containing material, in combination with at least one other metal oxide. In embodiments, the mixed metal oxide particle deposition 116 comprises a solid solution of ceria and zirconia. In embodiments, the mixed metal oxide particle deposition 116 comprises a high surface area inorganic material such as alumina, for example, gamma alumina, in addition to the ceria and/or ceria-zirconia solid solution. For example, the inclusion of alumina, such as gamma alumina, or other high surface area inorganic material, may be useful in increasing the surface area made available by the particles of the mixed metal oxide particle deposition 116, thereby facilitating interaction with the gaseous hydrocarbon species during use. In embodiments, the mixed metal oxide particle deposition 116 comprises an inorganic binder such as boehmite, or another material comprising one or more precursors of the ceramic material of the walls 102, such as other silica-or alumina-containing inorganic binders. For example, the inorganic binder can assist in adhering the particles of the deposition 116 to the filter 200, such as after a heat treatment that at least partially sinters the particles of the deposition 116 together and/or to the ceramic material of the filter 200. One example of the solid components for the particle deposition 116 is provided in Table 1 below.

The particle deposition 116 can be applied to the filter 200 or other honeycomb body in any particle deposition process, such as spray-drying, dry powder deposition, slurry coating processes (on green or fired honeycomb bodies), pyrolysis processes, or other suitable process for depositing particles. In embodiments, the non-precious metal active component of the deposition 116, such as ceria or other ceria-containing material (e.g., a solid solution of ceria and zirconia) comprises at least 10 wt %, at least 15 wt %, at least 20 wt %, at least 25 wt %, or even at least 30 wt % with respect to the solid components of the deposition 116, such as up to 70 wt %, 80 wt %, 90 wt % or even 100 wt %, or a range including any of these values as end points. In embodiments, the non-precious metal active component, such as ceria or other ceria-containing material, is present in a range from 10 wt % to 100 wt %, such as at least 25 wt % to 100 wt %.

In embodiments, the non-precious metal active component comprises ceria in an amount of at least 30 wt % ceria, at least 40% ceria, or even at least 50 wt % ceria, such as up to 80 wt %, 90 wt %, or even 100 wt % ceria. In embodiments, the mixed metal oxide deposition as a whole comprises ceria in an amount of at least 5 wt %, at least 8 wt %, at least 10 wt %, at least 15 wt %, or even at least 20 wt %, such as even up to 50 wt % or more of the solid component of the deposition 116, or a range including any combination of these values as end points. In embodiments in which the non-precious metal active component is a ceria-zirconia solid solution, the balance of the solid solution that is not ceria can comprise zirconia. In embodiments, the solid solution of ceria and zirconia comprises ceria in a greater amount than zirconia. In embodiments, the non-precious metal active component comprises zirconia in an amount of at least 20 wt %, at least 30 wt %, or even at least 40 wt %, such as up to 50 wt %, or a range including any combination of these values as end points.

In embodiments, the particle deposition 116 comprises no alumina or other high surface area inorganic material (with the exception of possible trace amounts, e.g., less than 0.1 wt %). In other embodiments, the particle deposition 116 comprises the high surface area inorganic material, such as alumina, or in particular gamma alumina, in an amount of at least 10 wt %, at least 20 wt %, at least 30 wt %, at least 40 wt %, at least 50 wt %, or even at least 60 wt % of the solid component of the particle deposition 116, such as up to 65 wt % or 70 wt % or a range including any combination of these values as end points. In embodiments, the particle deposition 116 comprises alumina as both a high surface area material and as an inorganic binder, particularly where alumina is a precursor of the ceramic material of the filter 200. In some embodiments, the particle deposition 116 comprises alumina as both a high surface area material and as part of the non-precious metal active component. However, in some embodiments the mixed metal oxide deposition comprises no, or essentially no, alumina, and instead comprises essentially only the other non-precious metal active components, e.g., only ceria and zirconia, such as a solid solution of ceria and zirconia.

In embodiments, the particle deposition 116 comprises an inorganic binder, separate from the high surface area material (if included), such as boehmite, in an amount of at least 2 wt %, at least 5 wt %, at least 10 wt %, or even at least 15 wt % of the solid component of the particle deposition 116, such as up to 20 wt % or 25 wt % or a range including any combination of these values as end points.

In embodiments, the mixed metal oxide deposition 116 is provided at a total solid loading of at most 50 g/L, at most 40 g/L, at most 30 g/L, at most 20 g/L, or even at most 10 g/L, with respect to the volume of the filter or substrate in which the deposition is loaded. The volume of the filter can be determined by a closed frontal area of the filter walls 102 multiplied by a length of the filter. For example, in embodiments, the mixed metal oxide deposition is present in a solid loading from 5 g/L to 50 g/L, from 5 g/L to 40 g/L, from 5 g/L to 30 g/L, from 5 g/L to 25 g/L, from 5 g/L to 20 g/L, from 5 g/L to 15 g/L, or even from 5 g/L to 10 g/L. For example, the particle deposition 116 may be present in relatively lower amounts (e.g., 5 g/L to 10 g/L) when the deposition comprises a higher percentage of the non-precious metal active component, e.g., when only relatively small amounts of the inorganic binder and/or high surface area material are needed for a particular use case.

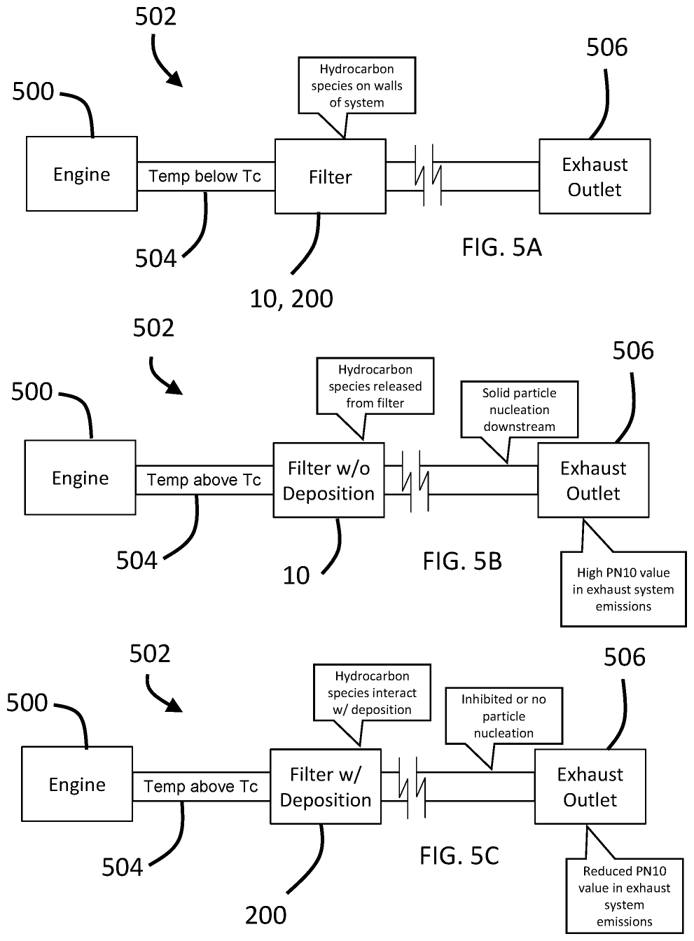

To assist in description of possible applications of particulate filters 200 comprising the mixed metal oxide particle deposition 116, FIGS. 5A-5C illustrate three hypothetical scenarios for an engine 500 coupled to an exhaust aftertreatment system 502 via an exhaust line or pipe 504, which terminates in a tailpipe or other exhaust port or outlet 506. In particular, FIG. 5A illustrates a first scenario in which the exhaust aftertreatment system 502 comprises either a bare filter 10 that does not comprise the mixed metal oxide particle deposition 116 or the filter 200 which does comprise the mixed metal oxide particle deposition 116 and in which the exhaust temperature is maintained below a threshold or critical temperature Tc; FIG. 5B illustrates a second scenario in which the exhaust aftertreatment system 502 comprises the bare filter 10 (which does not comprise the mixed metal oxide particle deposition 116) and in which the exhaust temperature is above the critical temperature Tc; and FIG. 5C illustrates a third scenario in which the exhaust aftertreatment system 502 comprises the filter 200 (which does comprise the mixed metal oxide particle deposition 116) and in which the exhaust temperature is above the critical temperature Tc.

Without wishing to be bound by theory, it is believed that during operation of an internal combustion engine (e.g., the engine 500) certain gaseous molecules, such as polycyclic aromatic hydrocarbons (PAHs) or other gaseous hydrocarbon species may collect on or in a particulate filter (e.g., bare filter 10 and/or filter 200) for the internal combustion engine. As long as a corresponding threshold or critical temperature is not reached (e.g., the temperature from the engine 500 stays below the critical temperature Tc as in the scenario of FIG. 5A), it is believed that these gaseous hydrocarbon species remain within the particulate filter of the aftertreatment system.

However, as in the case of FIG. 5B, upon certain engine operational conditions, such as reaching a corresponding threshold or critical temperature (e.g., the scenario in FIG. 5B), it is believed that the molecular hydrocarbon species may volatilize, causing these gaseous molecules to release from the bare filter 10 and to travel along the exhaust line 504 toward the tailpipe or other exhaust port 506. It is believed that the cooling experienced as the molecular hydrocarbon species travel toward the exhaust port 506 may result in the nucleation of solid particulate matter from gaseous molecular hydrocarbon species. The term nucleation as used herein shall mean any physical and/or chemical process by which hydrocarbon species cluster, group, agglomerate, or attach together to form solid particulate matter. As a result, this solid particulate matter can be monitored in the form of the very fine nanoparticles described herein, i.e., nanoparticles having a size of less than 23 nanometers, such as from 10 nanometers to less than 23 nanometers.

In contrast, the formation of this solid particulate matter (and thus the emission of very fine nanoparticles) can be advantageously inhibited by use of the filter 200 comprising the mixed metal oxide particle deposition 116 as shown in FIG. 5C. In particular, it is believed that one or more components in the mixed metal oxide particle deposition 116 interact with the gaseous hydrocarbon species to prevent, reduce, or otherwise inhibit the nucleation of solid particulate matter, thereby in turn preventing, reducing, and/or otherwise inhibiting the formation and subsequent release of the very fine nanoparticles from the exhaust outlet 506. Still without wishing to be bound by theory, it is believed that the materials described herein for the mixed metal oxide containing particle deposition, such as ceria particles, particles comprising a solid solution of ceria and zirconia, or and/or alumina particles, work to crack the hydrocarbon species into smaller components that do not readily undergo the solid particulate matter nucleation described above with respect to the scenario of FIG. 5B.

It is further believed that the value of the critical temperature Tc and/or the formation of these molecular hydrocarbon species may be affected by other parameters, such as the ambient temperature or the aggressiveness of the operation of the engine 500, with lower ambient temperatures, faster accelerations, and rapidly cycling accelerations all believed to exacerbate the formation of the very fine nanoparticles (particles less than 23 nm in size).

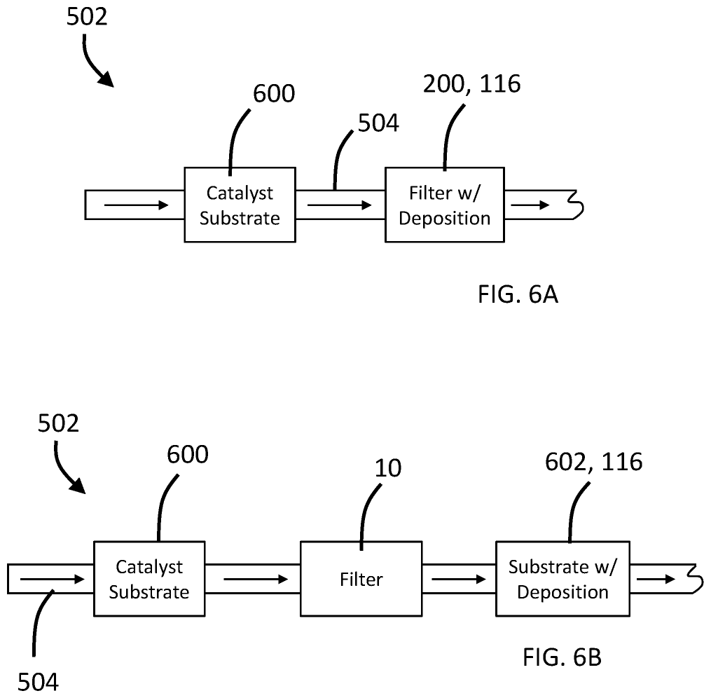

FIGS. 6A and 6B illustrate portions of the exhaust aftertreatment system 502 according to further embodiments. In FIG. 6A, the filter 200 comprises the deposition 116 and is provided downstream of an upstream substrate 600 that comprises a precious metal-containing catalyst material, e.g., a conventional catalyst material, such as a three-way catalyst material. For example, the catalyst material carried by the upstream substrate can comprise a non-trace amount, e.g., at least 1 wt % precious metals, and typically more at a level depending on the particular catalytic activity desired. By upstream it is meant that the upstream substrate 600 is located closer to the engine (e.g., the engine 500 of FIGS. 5A-5C, but not shown in FIGS. 6A and 6B) than the filter 200, such that the exhaust gas from the engine flows through the upstream substrate 600 before reaching the filter 200. For example, the upstream substrate 600 can resemble the honeycomb body 100 (unplugged) that has been coated with a selected catalyst material, such as a three-way catalyst (TWC) that comprises one or more precious metals. As stated above, it is believed that the formation of at least some of the very fine particles (e.g., particles having a size less than 23 nm) occurs at, in, or downstream of the filter 200. Accordingly, while the aftertreatment system 502 as a whole may contain precious metal catalyst material, the presence of this precious metal catalyst material in the upstream substrate 600 does not affect the emission of the above-described very fine particles addressed by the mixed metal oxide deposition 116.

While many embodiments herein describe the mixed metal oxide deposition as located within the filter 200, the mixed metal oxide deposition 116 could be present at a location downstream of a filter, such that the filter itself does not comprise the mixed metal oxide particle deposition 116. For example, as shown in FIG. 6B, any PAHs or other gaseous hydrocarbon species released from the bare filter 10 (which does not comprise the deposition 116) will travel downstream of the bare filter 10. For this reason, the mixed metal oxide deposition 116 can be present on another body, such as a downstream substrate 602 that comprises the deposition 116 and is located downstream of the bare filter 10. For example, the downstream substrate 602, similar to the upstream substrate 600, can be arranged as a porous ceramic honeycomb body, such as the honeycomb body 100 and the deposition 116 applied thereto as described herein with respect to the filter 200. In this way, the deposition 116, present on the downstream substrate 602, can be beneficially used to reduce the emission of very fine particles from the aftertreatment system 502 as described above. In embodiments, the deposition 116 can be present on both the filter and on the downstream substrate 602 (e.g., the filter 200 in combination with the downstream substrate 602). In either embodiment of FIGS. 6A or 6B, the emission of very fine particles is advantageous achieved with no precious metal catalyst material (with the exception of possible trace amounts, e.g., less than 0.1 wt %) present at, or downstream of, the filter 200.

Accordingly, use of the filter 200 comprising the mixed metal oxide particle deposition 116, and/or use of the deposition 116 in a substrate downstream of a bare filter, can be useful in inhibiting the formation and/or subsequent emission of very fine nanoparticles (particles having a size less than 23 nm, such as particles having a size from 10 nm to 23 nm). Furthermore, the formation and/or subsequent release of these very fine nanoparticles can be achieved without the use of traditional catalyst materials, i.e., without the use of precious metals.

### EXAMPLES

In a first experiment, the filtration performance of two particulate filters was compared. The particulate filters were of the type suitable for use in filtering particulate from a gasoline fueled engine, which may be referred to as gasoline particulate filters, or GPFs. In particular, one of the GPFs had a mixed metal oxide particle deposition in accordance to the disclosure herein, while the other GPF did not have such a mixed metal oxide particle deposition. The gasoline particulate filter without the mixed metal oxide particle deposition may be referred to herein as GPF1, while the gasoline particulate filter with the mixed metal oxide particle deposition may be referred to herein as GPF2. Both gasoline particle filters were created generally resembling the filter 200. In particular, each of the GPFs had a honeycomb body of a porous cordierite material having a porosity of about 55%, approximately 200 cells (channels) per square inch, and a wall thickness of approximately 8-9 mils. The GPFs were arranged as filters by plugging alternate channels at the inlet and outlet faces in corresponding checkerboard patterns. Each of the GPFs was also provided with a first deposition of filtration particles generally in accordance with the aforementioned '071 Publication to provide the GPFs each with alumina-based nanoparticle depositions on the surfaces of the inlet channels of the GPFs. GPF2 was additionally submerged in a washcoat slurry as described below with respect to Tables 1-3 in order to provide GPF2 with the mixed metal oxide particle deposition as described herein. The particulate number (PN) filtration efficiency for particles above about 300 nm was 99.7% for GPF1 and about 97.3% for GPF2. The slightly lower filtration of GPF2 was expected due to the mixed metal oxide particle deposition, similar to the relatively lower filtration efficiencies seen by filters loaded with catalyst mixtures by catalyst-containing washcoat slurries.

Table 1 shows the amounts, in weight percent, of the solid components of the washcoat slurry in which GPF2 was submerged in order to form the mixed metal oxide particle deposition on GPF2.

TABLE 1

| | Wt % (dry) |
|---|---|
| γ-alumina | 55 |
| Ceria-Zirconia | 30 |
| (58% Ce − 42% Zr) | |
| Boehmite binder | 15 |
| Precious Metals | 0 |

As appreciated from Table 1, the mixed metal oxide particles deposited in GPF2 specifically comprised particles of ceria-zirconia in solid solution as well as gamma alumina and a boehmite binder. The washcoat slurry utilized for GPF2 comprised no precious metal particles (0 wt % precious metals).

Table 2 shows additional details of the particles in the washcoat slurry of Table 1, namely the d10, d50, and d90, the surface area, the average pore size, and the pore volume, as applicable, of the various inorganic particles in the washcoat slurry. Only the d50 is provided for the boehmite binder.

TABLE 2

| | Particle size | | | |
|---|---|---|---|---|
| | distribution | Surface | Avg. Pore | Pore volume |
| Component | (d10, d50, d90) (μm) | Area (m2/g) | size (nm) | (cm3/g) |
| γ-alumina | 1.6, 2.6, 3.9 | 135 | 8.1 | 0.326 |
| Ce—Zr | 0.6, 2.3, 5.6 | 105 | 6.4 | 0.179 |
| (58% Ce + 42% Zr) | | | | |
| Boehmite binder | d50 = 20 nm | — | — | — |

In particular, GPF2 was submerged, outlet-side first, in a first washcoat slurry where the mixture of Table 1 was diluted in water to a solid concentration of between 20-30 wt % and a second washcoat slurry where the mixture of Table 1 was diluted in water to a solid concentration of between 10-20 wt %. GPF2 was dried between the two submersions and then calcined at approximately 550° C. for 3 hours. The mixed metal oxide particle deposition was added to a total loading of about 90 g/L with respect to the volume of the honeycomb body of GPF2.

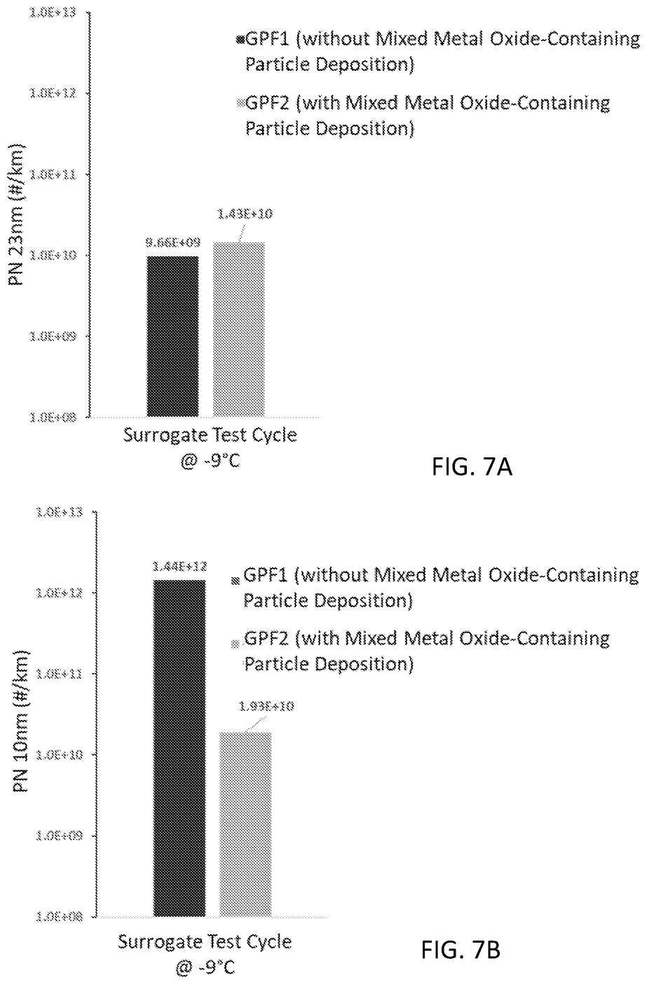

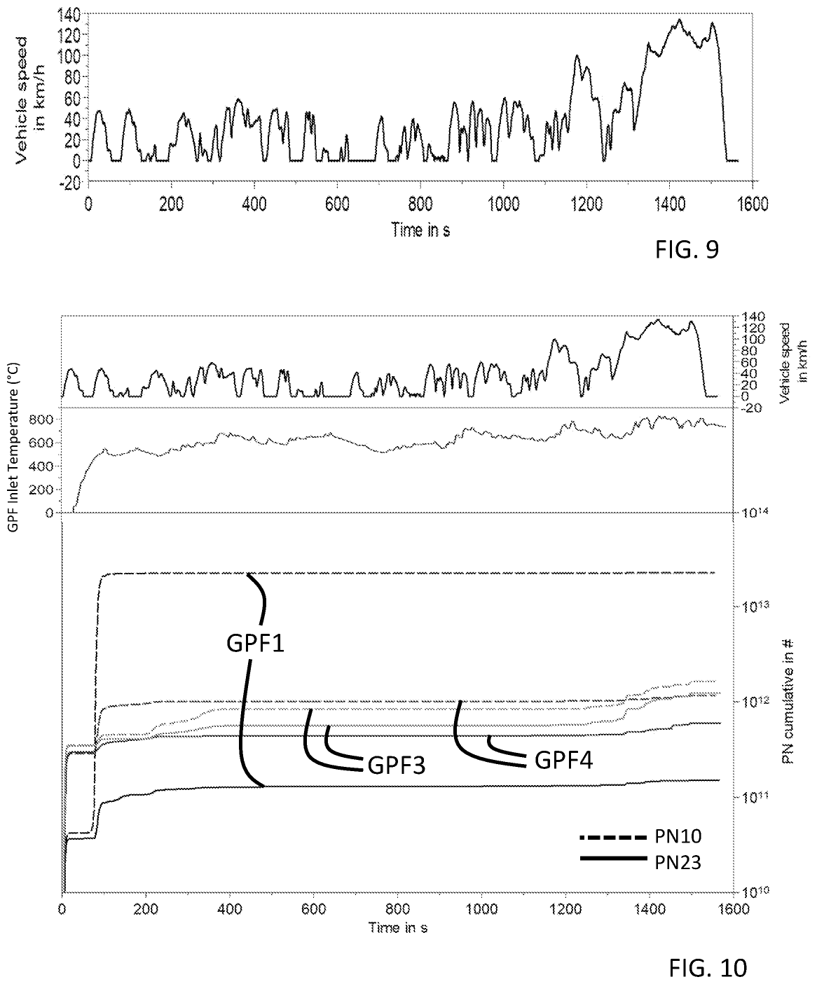

The performance of GPF1 and GPF2 is comparatively shown for PN23 and PN10 in FIGS. 7A and 7B, respectively. The data of FIGS. 7A and 7B was generated by monitoring the emissions of a vehicle having a turbo gas direct injection engine driven on dynamometer equipment at −9° C. according to a surrogate test cycle that simulates the Real Driving Emissions (RDE) test cycle. The test cycle utilized for testing is shown in FIG. 9, with the speed of the vehicle in km/h plotted with respect to time in seconds. As shown, the test cycle included a number of repeated accelerations and decelerations to various speeds.

As shown in FIG. 7A the PN23 filtration performance of GPF2 (comprising the mixed metal oxide particle deposition) was slightly less than the corresponding filtration performance of GPF1. This slightly worse performance is not unexcepted, as similar decreases in filtration efficiency are seen for particulate filters having other particle depositions, such as those that are provided with standard catalyst washcoats. However, GPF2 surprisingly outperformed GPF1 drastically for the PN10 measurement (again, referring to particles greater than 10 nanometers in size) as shown in FIG. 7B. Specifically, it is to be appreciated that FIGS. 7A and 7B are illustrated on log-scales with each subsequent marking on the y-axis (ordinate) representing multiplication by a further power of ten, and thus, GPF2 performed multiple orders of magnitude better than GPF1 with respect to the PN10 measurement. Furthermore, these unexpected results occurred with GPF2 containing no precious metals, which would be contained in traditional catalyst washcoats.

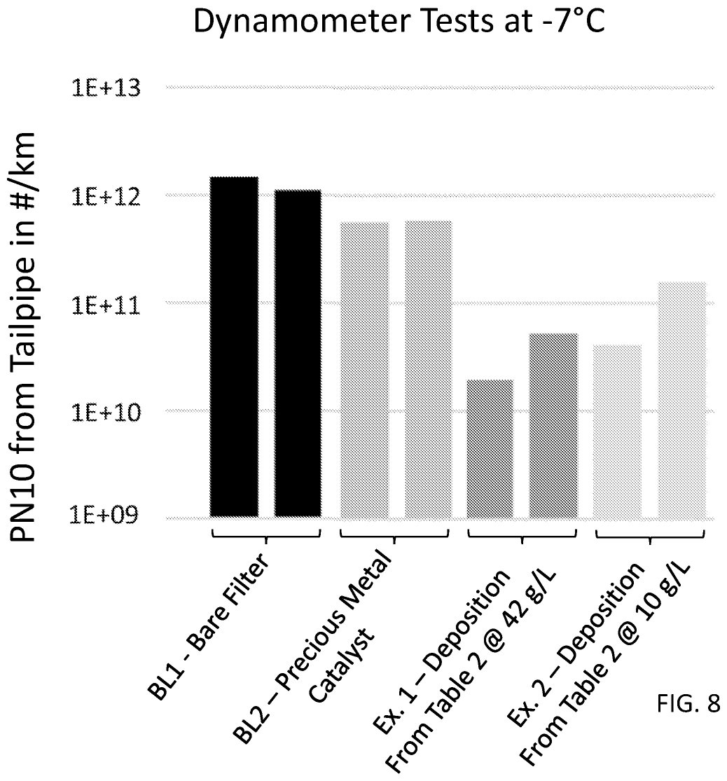

According to another experiment, FIG. 8 illustrates PN10 measurements for two different test cycles performed on a dynamometer under simulated driving conditions at −7° C. ambient temperature by a vehicle equipped with four different filter arrangements. In particular, the number of 10 nm or larger-sized particles (PN10) per kilometer of simulated driving on the dynamometer was collected. The same type and geometry of filter was utilized in each test, but with a different catalyst or mixed oxide particle deposition material applied as indicated. The filter selected for each test were cordierite filters having approximately 200 cells per square inch, 8.5 mil nominal wall thickness, and 55% porosity, with an alumina nanoparticle deposition on the walls of its inlet channels, as described generally in US Patent Publication 2021/0354071, referenced herein above. The tested filters were arranged in an exhaust aftertreatment system akin to that illustrated in FIG. 6A with a TWC-loaded substrate provided upstream of the tested filter.

The filters were arranged in four different configurations: a first “bare” filter with only the alumina nanoparticle deposition but no catalyst coating (“BL 1”), a second filter having a platinum-and palladium-based catalyst coating akin to a conventional diesel oxidation catalyst coating (“BL2”), a third filter having the mixed metal oxide particle deposition from Table 2 as described herein at a loading of approximately 42 g/L, and a fourth filter having the mixed metal oxide particle deposition from Table 2 as described herein at a loading of approximately 10 g/L. Thus, the first filter (BL1) generally resembled GPF1 in the experiment above, while the third and fourth filters generally resembled GPF2 but at a reduced loading for the mixed metal oxide particle deposition.

From the testing summarized in FIG. 8, it was seen that a significant amount of PN10 sized particles were emitted under the scenario of the filter having no catalyst, shown as baseline example BL1. It is noted that this performance of example BLI is despite the presence of a conventional TWC-loaded substrate located upstream of the (e.g., akin to the upstream substrate 600 of FIGS. 6A and 6B). Thus, BL1 can be treated as a baseline for the number of PN10 particles (particles having a size of at least 10 nm) expected to be emitted under the testing conditions. Similarly, example BL2 provides a secondary baseline for the use of conventional precious metal catalyst materials (particularly in the form of palladium and platinum) loaded onto the filter itself. In baseline example BL2, the use of the precious metal-containing catalyst was observed to reduce the number of PN10 particles only slightly in comparison to the baseline of example BL1.

In contrast, the mixed metal oxide deposition from Table 2 was applied at a loading of 42 g/L in Ex. 1, which was observed as resulting in a significant impact on the PN10 emissions. In particular, the PN10 emissions for Ex. 1 were reduced by over an order of magnitude in comparison to the baseline of example BLI and by about an order of magnitude with respect to the example BL2 (it is again noted that, similar to FIGS. 7A-7B, the results of FIG. 8 are plotted logarithmically). Furthermore, even when the solid loading of the mixed metal oxide deposition of Table 2 was reduced to 10 g/L in Ex. 2, the PN10 emissions were still reduced by about an order of magnitude in comparison to the bare baseline BL1. Accordingly, the mixed metal oxide particle deposition provided herein surprisingly results in a significant reduction in the emission of very fine nanoparticles (e.g., less than 23 nm, such as from 10 nm to 23 nm sized particles) in comparison to both “bare” and catalyst-coated filters of comparable geometry.

Without wishing to be bound by theory, it is believed that the exhaust aftertreatment system may be oxygen starved during the period in which the PN10 particle emissions occur (e.g., following cold start of the engine), which may hinder the ability of a precious metal catalyst-coated filter, such as in baseline BL2, from treating PN10 sized particles, while the ceria-zirconia material utilized in the mixed metal oxide depositions described herein, e.g., as in Ex. 1 and Ex. 2, function suitably under these operational conditions.

In another experiment, further gasoline particulate filters, namely GPF3 and GPF4,were prepared with mixed metal oxide depositions as described herein. Unlike GPF2 discussed with respect to the first experiment above, the mixed metal oxide depositions in GPF3 and GPF4 were applied to particulate filters that did not already have an alumina nano-particle deposition. In particular, Table 3 describes the two different slurries that were each prepared, spray-dried, and then pulled via vacuum and deposited into a bare 55% porosity cordierite particle filter for each of GPF3 and GPF4. Both GPF3 and GPF4 were subjected to a 550° C. heat treatment after deposition. All values in Table 3 are presented in wt % with respect to a total weight of the corresponding slurry and the binder utilized was of the Dowsil US-CF-2405 type made available from The Dow Chemical Company. Table 4 provides the relative composition of just the inorganic raw materials in the mixed metal oxide particle deposition in wt %. Accordingly, GPF3 utilized a deposition that included both alumina and ceria-zirconia as inorganic raw materials, while GPF4 utilized only ceria-zirconia (essentially 0 wt % alumina) as an inorganic. The deposition process was performed as generally described in the aforementioned '071 Publication, except with the slurries of Table 3 in lieu of the slurries described in that publication.

TABLE 3

| | γ- | | | Acetic | | | | Triblock |
|---|---|---|---|---|---|---|---|---|
| Example | Alumina | Boehmite | Ce—Zr | Acid | Water | Ethanol | Binder | Copolymer |
| GPF3 | 6.86 | 1.87 | 3.74 | 0.2 | 87.32 | 0 | 0 | 0 |
| GPF4 | 0 | 0 | 17.32 | 0 | 0 | 79.11 | 2.60 | 0.96 |

TABLE 4

| | γ- | | |
|---|---|---|---|
| Example | Alumina | Boehmite | Ce—Zr |
| GPF3 | 55 | 15 | 30 |
| GPF4 | 0 | 0 | 100 |

GPF1 (no mixed metal oxide particle deposition), GPF3 (30% Ce—Zr), and GPF4 (100% Ce—Zr) were installed in the exhaust aftertreatment system of a 1.2 L engine vehicle and subjected to the simulated RDE test cycle of FIG. 9. FIG. 10 illustrates the filtration performance of GPF1, GPF3, and GPF4 with respect to both PN10 and PN23 sized particles. In particular, the PN10 performance is indicated by dashed lines, while the PN23 performance is indicated by solid lines. Additionally, FIG. 10 reproduces the speed of the vehicle during the test cycle (same as FIG. 9) as well as the temperature at the inlet of the GPF on the same time scale together with the particle filtration performance.

Similar to the discussion with respect to baseline BL1 above, the PN23 filtration performance of GPF1 was very high, but the PN10 performance was comparatively poor. As shown in FIG. 10, the PN10 performance of both GPFs having a mixed metal oxide deposition (both GPF3 and GPF4) exceeded that of the GPF having only alumina (GPF1) in that each of GPF3 and GPF4 emitted more than an order of magnitude fewer PN10 particles than GPF1.

From FIG. 10, it can be seen that a significant portion of emissions of the PN10 and PN23 particles occurs toward the start of the test cycle (e.g., following “cold start” of the engine), while the temperature in exhaust aftertreatment system is still increasing. However, there is a noted separation at around 100 s where the PN23 particle emissions begin to plateau for all GPFs tested, but the PN10 emissions rise sharply. This is seen most prominently in GPF1, where the PN10 and PN23 separate drastically starting at about the 100 s. As described above with respect to FIGS. 5A-5C, this sudden and significant increase in PN10 emissions for GPF1 is believed to occur due to the formation of these PN10 sized particles from released gaseous phase hydrocarbons following the initial increase of the exhaust aftertreatment temperature to a few hundred degrees Celsius. However, such a significant increase in PN10 emissions is prevented for GPF3 and GPF4 by the use of the mixed metal oxide depositions described herein.

From FIG. 10, it can be seen that both GPF3 having 30 wt % Ce—Zr (with respect to total inorganics) and GPF4 having 100 wt % Ce—Zr significantly inhibited the emission of PN10 particles relative to the GPF1. Accordingly, it is to be appreciated that alumina can be optionally included as part of the particle deposition, as in the example of GPF3, but it is not necessary, as in the example of GPF4.

While each of the examples of GPF3 and GPF4 were successful in inhibiting the emission of particles less than 23 nanometers in size, their different compositions offer a tradeoff in performance with respect to each other. For example, by the end of the utilized test cycle, GPF4 exhibited less total cumulative emissions for both PN10 and PN23 measurements in comparison to GPF3, while GPF3 exhibited a lower emission of the portion corresponding to the very fine nanoparticles. That is, as used herein, the very fine nanoparticles refers to the particles greater than 10 nm but smaller than 23 nm, which can be determined as the difference between the dashed (PN10) and solid (PN23) lines (that is, PN10 minus PN23). Thus, while GPF3 did have overall a greater amount of cumulative emissions in comparison to GPF4, the portion of emissions corresponding to just the very fine nanoparticle sizes (e.g., less than 23 nm) was less than that achieved by GPF4, as evidenced by the extremely close spacing between the dashed and solid lines for GPF3. Accordingly, it may be possible to vary the alumina or other high surface area material or inorganic binder material relative to the ceria-containing material to adjust either the total filtration efficiency of the filter and/or the filtration efficiency of the portion corresponding to the very fine nanoparticles.

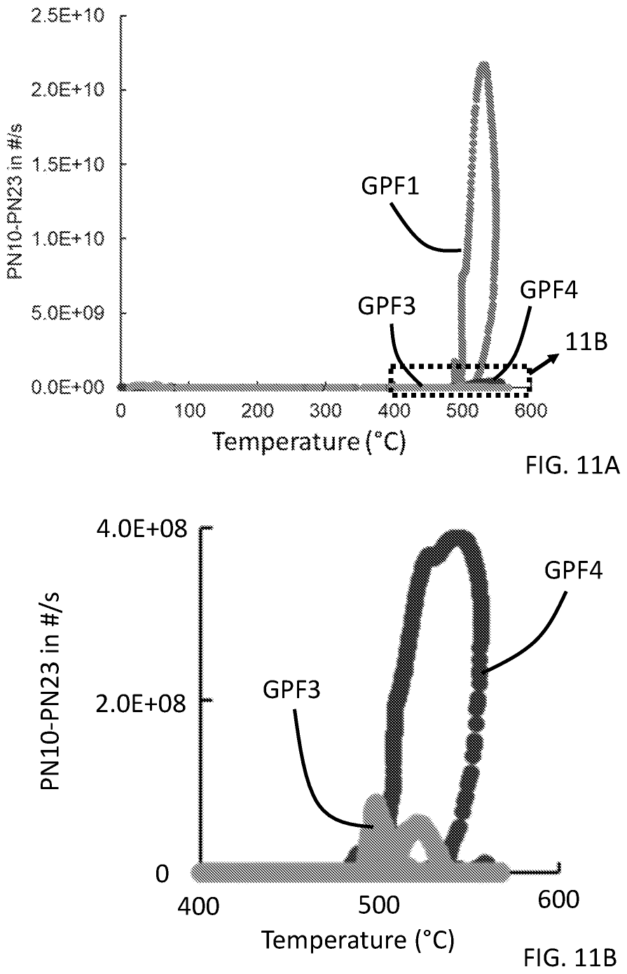

For further comparison, FIGS. 11A-11B illustrate the amount of particles having a size greater than 10 nm but smaller than 23 nm that were emitted per second during and immediately following the initial heat up of the exhaust aftertreatment system (i.e., corresponding to about the first 100 seconds). That is, the performance of FIGS. 11A-11B was obtained by subtracting the PN23 particle performance from the PN10 performance, thereby providing a measure of the number of particles greater than 10 nm, but smaller than 23 nm, which have been designated herein as “very fine nanoparticles”. Thus, instead of being presented on the same time scale as FIG. 10, the filtration performance of FIGS. 11A-11B is presented as the number of particles emitted per second with respect to the temperature of the exhaust aftertreatment system. FIG. 11B shows an enlarged view of the indicated portion of FIG. 11A so that the particle emission data for GPF3 and GPF4 can be more readily assessed. Accordingly, from FIGS. 11A-11B it can be seen that the exhaust aftertreatment system comprising GPF1 (without the mixed metal oxide particle deposition) emitted several orders of magnitude more particles per second in the size range of 10 nm to 23 nm during initial exhaust system heat up.

It will be apparent to those skilled in the art that various modifications and variations can be made without departing from the spirit or scope of the claimed subject matter. Accordingly, the claimed subject matter is not to be restricted except in light of the attached claims and their equivalents.

1. A method of inhibiting release of nano-sized particulate matter from engine exhaust, comprising:
flowing an exhaust stream through a wall-flow filter;
filtering particulate matter from the exhaust stream with the wall-flow filter;
interacting gaseous hydrocarbon species collected in the filter with particles of a mixed metal oxide particle deposition at or downstream of the filter to inhibit creation of very fine nanoparticles from the gaseous hydrocarbon species,
wherein the mixed metal oxide particle deposition comprises precious metals in an amount of less than 0.1 wt %.

2. The method of claim 1, wherein the mixed metal oxide particle deposition comprises a ceria-containing material.

3. The method of claim 1, wherein the mixed metal oxide particle deposition comprises a combination of ceria and zirconia.

4. The method of claim 3, wherein the ceria and zirconia are in solid solution.

5. The method of claim 4, wherein the solid solution comprises a higher percentage of ceria than zirconia.

6. The method of claim 4, wherein the solid solution comprises at least 50 wt % ceria.

7. The method of claim 1, wherein the mixed metal oxide particle deposition comprises a combination of ceria and alumina.

8. (canceled)

9. The method of claim 1, wherein the ceria-containing material has a particle size of from 1 μm to 5 μm.

10. (canceled)

11. The method of claim 1, wherein the loading of the mixed metal oxide particle deposition is from 5 g/L to 50 g/L.

12. (canceled)

13. (canceled)

14. The method of claim 1, wherein the very fine nano-particles have a particle size of less than 23 nm.

15. (canceled)

16. (canceled)

17. A wall-flow filter for inhibiting the emission of very fine nano-particles, comprising:
a honeycomb body comprising an intersecting array of filter walls formed of a porous material and defining channels extending through the honeycomb body between an inlet face and an outlet face of the filter, wherein the channels comprise a first plurality of inlet channels that are open at the inlet face and plugged at the outlet face and a second plurality of outlet channels that are open at the outlet face and plugged at the inlet face; and
a mixed metal oxide particle deposition on surfaces of the filter walls, in the porous material of the filter walls, or a combination thereof;
wherein the mixed metal oxide particle deposition comprises precious metals in an amount of less than 0.1 wt %.

18. The wall-flow filter of claim 17, wherein the mixed metal oxide particle deposition comprises a ceria-containing material.

19. The wall-flow filter of claim 17, wherein the mixed metal oxide particle deposition comprises a combination of ceria and zirconia.

20. The wall-flow filter of claim 19, wherein the ceria and zirconia are in solid solution.

21. The wall-flow filter of claim 20, wherein the solid solution comprises a higher percentage of ceria than zirconia.

22. The wall-flow filter of claim 20, wherein the solid solution comprises at least 50 wt % ceria.

23. The wall-flow filter of claim 17, wherein the mixed metal oxide particle deposition comprises a combination of ceria and alumina.

24. (canceled)

25. The wall-flow filter of claim 17, wherein the ceria-containing material has a particle size of from 1 μm to 5 μm.

26. (canceled)

27. The wall-flow filter of claim 17, wherein the loading of the mixed metal oxide particle deposition is from 5 g/L to 50 g/L.

28. (canceled)

29. The wall-flow filter of claim 17, wherein the mixed metal oxide particle deposition comprises ceria in an amount of at least 25 wt %.

30. The wall-flow filter of claim 17, wherein the very fine nano-particles have a particle size of less than 23 nm.

31. (canceled)

32. (canceled)

33. An exhaust aftertreatment system comprising:
a wall-flow filter comprising a first honeycomb body comprising an intersecting array of filter walls formed of a porous material and defining channels extending through the honeycomb body between an inlet face and an outlet face of the filter, wherein the channels comprise a first plurality of inlet channels that are open at the inlet face and plugged at the outlet face and a second plurality of outlet channels that are open at the outlet face and plugged at the inlet face;
a mixed metal oxide deposition at or downstream of the filter;
wherein the deposition comprises precious metals in an amount of less than 0.1 wt %.

34. The exhaust aftertreatment system of claim 33, wherein the mixed metal oxide deposition is on surfaces of the filter walls or in the porous material of the filter walls of the wall-flow filter.

35. The exhaust aftertreatment system of claim 33, wherein the mixed metal oxide deposition is carried by a downstream substrate located downstream of the wall-flow filter.

36. The exhaust aftertreatment system of claim 33, comprising an upstream substrate that carries a catalyst material, wherein the catalyst material comprises precious metals.
